(19) United States
(12) Patent Application Publication
(10) Pub. No.: US 2009/0022049 A1
(43) Pub. Date: Jan. 22, 2009

(54) NOVEL SECURITY ENHANCEMENT STRUCTURE FOR MIMO WIRELESS NETWORK

(75) Inventor: Dongsong Zeng, Germantown, MD (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/778,294

(22) Filed: Jul. 16, 2007

(51) Int. Cl. H04J 11/00; H04L 1/00

(52) U.S. Cl. 370/203; 380/278

(57) ABSTRACT

Techniques for enhancing the security and power efficiency of a multiple-input-multiple-output (MIMO) communication system are provided. In one embodiment, data packets are multiplexed by calculated spatial multiplexing matrixes (SMM). In one embodiment, the channel state information (CSI) is used to calculate a first transceiver's SMM to optimize channel efficiency. In another embodiment, the CSI is used to calculate a first transceiver's SMM to optimize channel secrecy.

### BACKGROUND

A multiple-input-multiple-output (MIMO) wireless network is a communication system with multiple antennas at both transmitter and receiver ends of a communication link. MIMO networks are typically optimized to the best channel efficiency, disregarding power efficiency and channel secrecy. Power efficiency decreases the transmitted power required for a successful communication. Channel secrecy, or communication security, reduces the chances that eavesdroppers will be able to successfully intercept the communication. While MIMO networks may provide some communication security, the security relies heavily on Medium Access Control (a data communication protocol sub-layer which is part of the data link layer providing channel access control) or upper layer authentication encryption techniques. These security techniques leave the communications insecure. Because there is little or no security, especially in the physical layer, eavesdroppers may monitor and determine the MIMO network communications. Additionally, many existing MIMO systems are designed in such a way that they tend to use excessive power to transmit the signal, thereby wasting power and increasing the probability of intercept.

For the reasons stated above and for other reasons stated below which will become apparent to those skilled in the art upon reading and understanding the present specification, there is a need in the art for a method and apparatus to increase the channel security and power efficiency of an MIMO communication system.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, a multiple-input-multiple-output wireless network is provided. The network includes a first transceiver with M antennas. The network also includes a second transceiver has N antennas. The first transceiver is configured to multiplex a data packet by a spatial multiplexing matrix and to transmit the spatially multiplexed data packet to the second transceiver. The first transceiver is reconfigurable to change the spatial multiplexing matrix to improve at least one characteristic of the transmission.

### BRIEF DESCRIPTION OF THE DRAWINGS

The present invention can be more easily understood and further advantages and uses thereof more readily apparent, when considered in view of the detailed description and the following figures in which:

FIG. 1 is a block diagram of one embodiment of a multiple-input-multiple-output wireless network for providing improved power efficiency or channel secrecy.

FIG. 2 is a block diagram of one embodiment of a transceiver in a multiple-input-multiple-output wireless network.

FIG. 3 is a block diagram of one embodiment of a multiple-input-multiple-output wireless network with improved security, where an eavesdropper is attempting to monitor the communications between the transmitter and receiver in the MIMO wireless network.

FIG. 4 is a flow chart of one embodiment of a method for enhancing the channel security and power efficiency of a multiple-input-multiple-output wireless network.

FIG. 5 is a flow chart of one embodiment of a method for a transceiver receiving a data packet in channel security of power efficiency mode of a multiple-input-multiple-output wireless network to recover the data packet.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention provide a system for enhancing the channel security or power efficiency of a multiple-input-multiple-output (MIMO) wireless network using a spatial multiplexing matrix (SMM). In one embodiment, the SMM is used to enhance communication security. In another embodiment, the SMM is used to enhance power efficiency. In one embodiment, the system includes a first transceiver with M antennas and a second transceiver with N antennas. The first transceiver is configured to transmit a data packet which has been multiplexed by a spatial multiplexing matrix. The first transceiver can be reconfigured to change the spatial multiplexing matrix for transmitting subsequent data packets. By reconfiguring the first transceiver to change the spatial multiplexing matrix, the channel security or power efficiency of the transmission can be enhanced. The transceivers have been described as directional for simplicity and are not limiting of the invention.

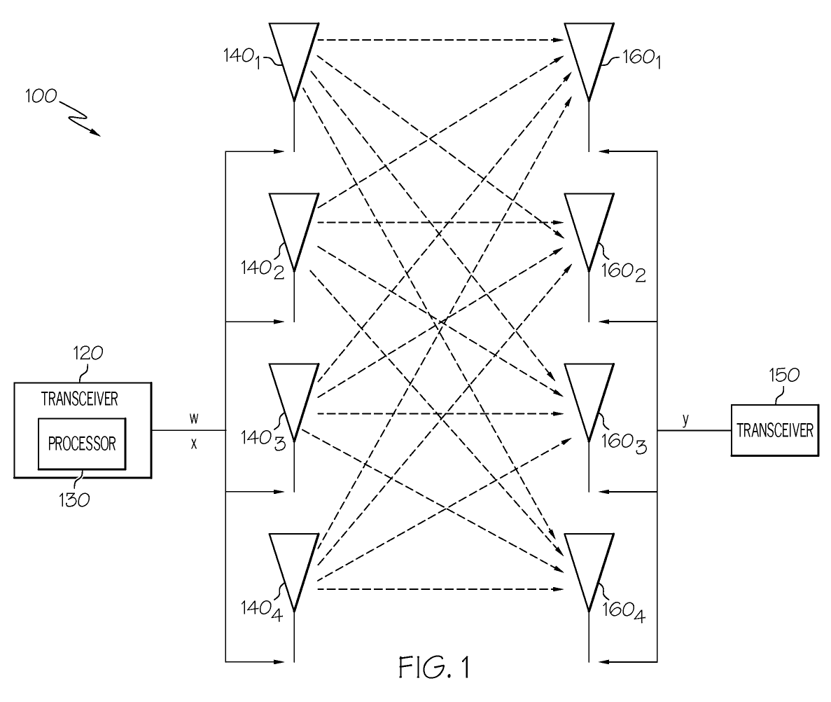

FIG. 1 is a block diagram of one embodiment of a multiple-input-multiple-output (MIMO) wireless network 100 for providing improved power efficiency or channel secrecy. In one embodiment, MIMO wireless network 100 may use at least one of spatial multiplexing MIMO techniques, pre-coding MIMO techniques, or diversity coding MIMO techniques. Spatial multiplexing MIMO techniques involve splitting a signal into a plurality of signal streams where each of the plurality of signal streams is transmitted from a different transmit antenna in the same frequency channel. Precoding MIMO techniques involve multi-layer beamforming to increase the gain at the receiving antennas. Diversity coding MIMO techniques involve transmitting a single signal stream that has been coded using space-time coding techniques.

In one embodiment, the MIMO wireless network 100 includes a first transceiver 120 with M antennas. As depicted, the first transceiver 120 includes four antennas 140₁, 140₂, 140₃, and 140₄. In other embodiments, different numbers of antennas may be used. In one embodiment, the MIMO wireless network 100 includes a second transceiver 150 with N antennas. As depicted, the second transceiver 150 includes four antennas 160₁, 160₂, 160₃, and 160₄. In other embodiments, different numbers of antennas can be used. In one embodiment, M is equal to N. In another embodiment, M does not equal N. If M does not equal N, only the smaller number of antennas will be used.

The first transceiver 120 also includes a processor 130. Processor 130 may include a central processing unit in a computer system, an integrated circuit, an application specific integrated circuit, a field-programmable gate array, a logic circuit, or the like. Processor 130 receives a data packet, denoted by x, to be transmitted by the first transceiver 120. A data packet, or signal, is information intended to be communicated.

Data packets are multiplexed in MIMO wireless system 100. Multiplexing refers to the process by which a signal is split up into a plurality of signals, or the process by which a plurality of signals are combined into one signal. Once a data packet is multiplexed into a plurality of signals, the first transceiver 120 can transmit the plurality of signals. In one embodiment, the number of signals the data packet is multiplexed into is equal to M antennas 140, and each antenna 140 transmits one signal. For example, in one embodiment the number of first transceiver 120 antennas 140 is four, and x is multiplexed into four signals. In other embodiments, the number of signals the data packet is multiplexed into is not equal to M antennas 140. The first transceiver 120 is shown to be transmitting by way of example not by way of limitation.

When data packet x is transmitted by the first transceiver 120, x is modified by the channel state information (CSI) matrix. The channel state information matrix, denoted by h, is information indicative of characteristics of the channel used to transmit the data packet. The CSI is dependent on the relative position of the first transceiver and the second transceiver, the propagation environment, antenna angles, antenna patterns, antenna polarizations, and the like. The propagation environment is affected by reflections, multi-path, diffractions, penetrations, scattering, and the like. Once a data packet x is transmitted by the first transceiver 120, x is modified by the CSI matrix h. The second transceiver 150 will receive signal y, which, treating any signal noise as negligent, can be defined as: y=hx.

The first transceiver 120 can estimate h, the CSI. Knowing h allows the MIMO network 100 to operate in channel secrecy mode or in power efficiency mode. In one embodiment, the second transceiver 150 transmits a pilot signal to the first transceiver 120 before the first transceiver 120 transmits a data packet. A pilot signal is a signal, typically of a single frequency, that MIMO system 100 can use as a reference signal. In one embodiment, the first transceiver 120 knows the pilot signal. The processor 130 uses the pilot signal to estimate the CSI. In another embodiment, the second transceiver 150 transmits the pilot signal in an acknowledgement signal. In another embodiment, the second transceiver 150 estimates h from a pilot signal which the first transceiver 120 transmits.

In another embodiment, the second transceiver 150 can estimate the CSI matrix h. In one embodiment, the first transceiver 120 transmits a request to send (RTS) signal to the second transceiver 150. The second transceiver 150 uses the RTS signal to estimate the CSI. The second transceiver 150 calculates the inverse matrix of the CSI, h⁻¹, and applies it to a clear to send (CTS) signal. The second transceiver 150 transmits the modified CTS signal to the first transceiver 120. The first transceiver 120 receives the clear CTS signal and can use the CTS signal to update the CSI matrix h. In another embodiment, the first transceiver 120 estimates h from a RTS signal which the second transceiver 150 transmits.

In one embodiment, h can be estimated using specially designed preambles. For example, the first transceiver 120 can generate a random number of information bits. If the second transceiver 150 knows the information bit sequence, the second transceiver 150 can use the information bit sequence to estimate h. In another embodiment, x can be estimated using the minimum mean squared error approach. The minimum mean squared error approach avoids the singularity problem that may occur if h is an invertible matrix by approximating h or h⁻¹. The second transceiver 150 can use the minimum mean squared error approach to recover x from the multiplexed signal. The mean clear signal can be defined as:

$$\text{?} = \sqrt{\frac{M}{{B}_{\text{?}}}} {( {h}^{*} h + \frac{{MN}_{0}}{{B}_{\text{?}}} I )}^{- 1} {h}^{*} y$$

$$\text{?} \text{indicates text missing or illegible when filed}$$

where M is the number of the plurality of multiplexed signals, Eₛ is the symbol energy, N₀ is the noise density contained in the received signal, h* is the conjugate transpose of h, and I is the identity matrix.

Before transmitting a data packet x, processor 130 may multiplex x by a spatial multiplexing matrix (SMM). A spatial multiplexing matrix is a matrix that can be applied to x before x is transmitted by the first transceiver 120. The SMM is denoted by W. The processor 130 may use the channel state information to determine what spatial multiplexing matrix, W, to calculate. W may be calculated differently depending on whether MIMO network 100 is operating in power efficiency or channel secrecy mode. The MIMO network 100 can derive the information of CSI matrix h and SMM W without taking extra communication bandwidth.

The first transceiver 120 may transmit the data packet x after processor 130 multiplexes x with W. The second transceiver 150 will receive signal y, which can be defined as: y=hWx. Any signal noise in the transmission may be neglected as very small. By applying a spatial multiplexing matrix to data packets to be transmitted, the MIMO wireless network 100 may achieve improved channel security and power efficiency. Improved channel security decreases the chances that an eavesdropper will be able to successfully intercept the communications. Improved power efficiency decreases the power required to transmit a signal to the intended target.

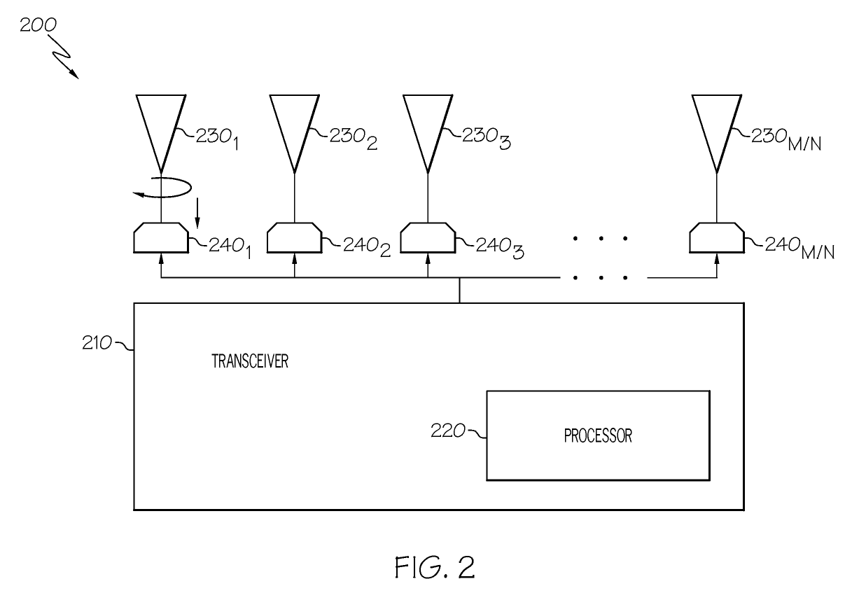

FIG. 2 is a block diagram of one embodiment of a transceiver 210 in a multiple-input-multiple-output wireless network 200. In one embodiment, processor 220 is connected to the transceiver 210. Transceiver 210 includes a plurality of antennas 230. Each of the plurality of antennas is connected to transceiver 210 via a servomechanism 240. Servomechanisms 240 are devices used to provide position control for attached objects. Processor 220 controls the function of the servomechanisms 240.

The channel state information (CSI) depends on a number of conditions. These conditions include the relative position of the transmitter and receiver, the propagation environment, antenna patterns, antenna polarizations, and the like. Changing any of these conditions typically changes the CSI matrix h. Changing antenna positions changes the CSI matrix h. Reconfiguring the antenna radiation characteristics in the physical layer changes the CSI matrix h. Changing the position of the antennas also changes the CSI matrix h.

In one embodiment, processor 220 controls the position of antennas 230 through servomechanisms 240. Servomechanisms 240 can rotate or tilt antennas 230. This change in position reconfigures the antenna radiation characteristics, thus changing the CSI matrix. Changing the CSI matrix h may require a corresponding change in the spatial multiplexing matrix W, depending on whether the MIMO wireless network is being operated in power efficiency mode or channel security mode. When operating in channel security mode, changing W at each opportunity will increase the security of the communications. When operating in power efficiency mode, W should be changed when the change in h reduces the power efficiency. Changing the CSI matrix h and the spatial multiplexing matrix W can result in improved power efficiency and channel security.

There are a plurality of ways to change the CSI matrix h. In one embodiment, servomechanism 240 tilts and rotates antennas 230 to change the CSI matrix h. In one embodiment, servomechanism 240 changes the position of antennas 230 between successive data packets sent or received. In another embodiment, servomechanism 240 changes the position of antennas 230 randomly between successive data packets sent or received. In one embodiment, all antennas 230 change position. In another embodiment, all antennas 230 change position in the same way. In another embodiment, only some of antennas 230 change position.

In one embodiment, antennas 230 implement Honeywell's reconfigurable antenna technology. For example, Honeywell's E-SCAN reconfigurable aperture antenna can be used, described in U.S. Pat. No. 6,985,109. Using the E-SCAN antenna allows the CSI matrix to be changed without using servomechanisms 240.

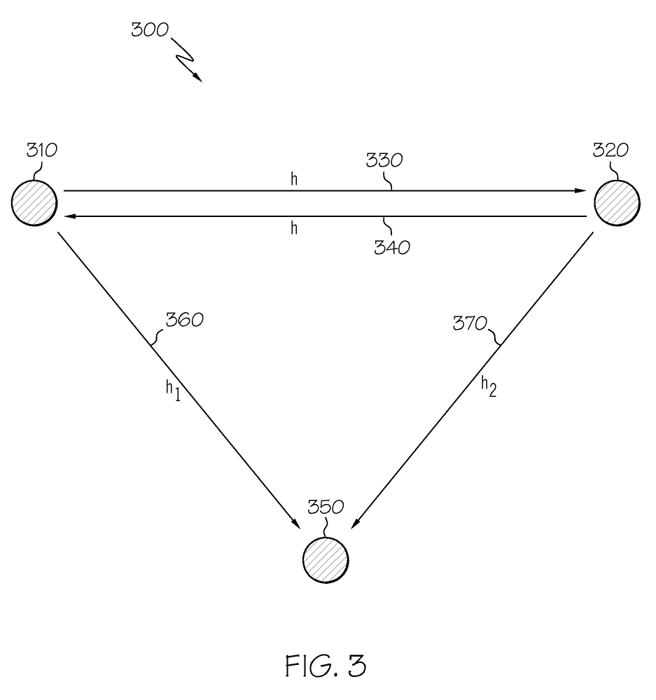

FIG. 3 is a block diagram of one embodiment of a multiple-input-multiple-output wireless network 300 with improved security, where an eavesdropper 350 is attempting to monitor the communications between the transmitter and receiver in the MIMO wireless network 300. As depicted, MIMO wireless network 300 is composed of Node 310 and Node 320. In one embodiment, Nodes 310 and 320 are transceivers. Node 310 transmits a data packet 330 to be received by Node 320. Transmitted data packet 330 has been modified by the CSI h. Node 320 may also transmit data packet 340 to be received by Node 310. Transmitted data packet 340 has been modified by the CSI h. The CSI from Node 310 to Node 320 is approximately equal to the CSI from Node 320 to Node 310 because the relative position and propagation environments are similar.

Node 350 is an eavesdropper. In one embodiment, eavesdropper 350 is sufficiently distant from Nodes 310 and 320 to be undetected by Nodes 310 and 320, but sufficiently close to detect communications between Nodes 310 and 320. The CSI from Node 310 to eavesdropper 350 is denoted as h₁. CSI h₁ does not equal CSI h because the relative positions and propagation environments are different. Likewise, h₂ does not equal h nor h₁. The CSI between Node 310 and Node 320 is different from the CSI between eavesdropper 350 and Node 310 and also different from the CSI between eavesdropper 350 and Node 320 because the relative positions of the transmitter and receiver, the propagation environment, antenna patterns, antenna polarizations, and the like are different for different paths.

The signal that eavesdropper 350 receives is modified by a different CSI than the signal that the target transceiver receives. If the signal has been multiplexed by a spatial multiplexing matrix (SMM) based on the target transceiver's channel state information before transmission, eavesdropper 350 will be unable to decode the signal. However, the target transceiver will be able to decode the signal based on the CSI between the transmitting transceiver and the target transceiver.

For example, in one embodiment, Node 310 transmits x multiplexed by the spatial multiplexing matrix W. Data packet x gets modified by a different channel state information matrix for each different path data packet x propagates in. The signal which eavesdropper 350 receives, denoted as r, is: \vec{r}=\vec{h₁}\vec{w}\vec{x}≠\vec{x}. Eavesdropper 350 can use r to determine the channel state information h₁. Once eavesdropper 350 has determined h₁, eavesdropper 350 can calculate the inverse matrix of h₁, h₁⁻¹. However, eavesdropper 350 will not be able to recover x by multiplying the received signal by h₁⁻¹. Instead, eavesdropper 350 recovers the signal: \vec{r}−\vec{W}\vec{x}. In order to recover the signal x, eavesdropper 350 must know W in order to apply W⁻¹ to the signal r. The eavesdropper 350 has no way to calculate W. At best, eavesdropper 350 guesses randomly at W. The eavesdropper 350 can either try every possible W to decode the received signal or suffer a significantly high bit error rate if the signal can be decoded at all.

In another embodiment, Node 310 transmits x multiplexed by the inverse channel state information matrix h⁻¹. Node 320 receives the clear signal x. Eavesdropper 350 receives a signal, denoted r, which is: \vec{r}=\vec{h₁}\vec{h⁻¹}\vec{x}≠\vec{x}. Eavesdropper 350 can use r to determine the channel state information h₁. Multiplying the received signal by h₁⁻¹, the eavesdropper obtains: \vec{r}=\vec{h⁻¹}\vec{x}. Again, eavesdropper 350 cannot resolve the received signal into the data packet x without randomly guessing at h or suffering significantly high bit error rates. Multiplexing x with the SMM h⁻¹ allows the communication to be secure from eavesdroppers while allowing for the target transceiver to receive a clear signal.

The communication will be more secure the faster CSI matrix h is changing, because eavesdropper 350 has less time to guess h accurately and timely. If h is not changing fast, eavesdropper 350 may have a better chance of determining h by exhausting the focal points of h. In one embodiment, the CSI matrix h is changing quickly with respect to the data packet duration.

In one embodiment, the SMM W can be randomized. By randomizing W, eavesdropper 350 will have a very difficult time breaking W to decode the data packet x. As long as hW is a diagonal matrix, the target transceiver will be able to decode the received signal. A diagonal matrix is a matrix where the diagonal elements are non-zero, and the non-diagonal elements are zero. In one embodiment, processor 220 can randomize the CSI h by randomly adjusting the transceiver antennas at both ends of the MIMO wireless network. In another embodiment, h may be randomized by changing the propagation conditions in the channel between Node 310 and Node 320. By randomizing h, W may also be randomized, subject to hW being a diagonal matrix. Processor 220 can calculate W such that hW is a diagonal matrix using various linear algebra methods known to those skilled in the art.

In another embodiment, h can be quantized to single number. Quantizing the CSI matrix involves reducing the matrix to one scalar number. Processor 220 can calculate h such that h is quantized into a single scalar number. For example, if h is a four by four matrix, h consists of sixteen elements. All sixteen elements may be quantized into one scalar number. A matrix may be quantized by adding all its elements together, adding the elements and taking a logarithm, taking an exponential, taking an exponential then adding the elements, and the like. In one embodiment, the scalar is an integer.

In one embodiment, Nodes 310 and 320 know what scalar the CSI matrix is quantized to. In one embodiment, the integer which the CSI matrix is quantized to is kept secret between Nodes 310 and 320. In another embodiment, the integer is used as an index to a shared secret codebook, program, or the like, giving a secret key. The secret key can be passed to upper layers for encryption or authentication of data packets. The secret key can be used to decode the data packet. The secret key can be generated and utilized with no public discussion which would compromise the security of the communications.

The MIMO wireless network can also be configured to operate in a power efficiency mode. In one embodiment, processor 130 uses eigenvectors of the CSI matrix h to beamform on the target second transceiver 150. Beamforming is a technique used to control the transmitted signal direction. The CSI matrix h can be written as: \vec{h}=\vec{v}\vec{λ}\vec{v}⁻¹ where λ is the eigenvalue matrix of h and v is the eigenvector matrix of h. The eigenvalue matrix λ can be defined as the diagonal matrix:

$${λ}^{->} = ( \begin{matrix}{λ}_{1} & ⋯ & 0 \\ ⋮ & ⋰ & ⋮ \\ 0 & ⋯ & {λ}_{M}\end{matrix} ) .$$

The eigenvector matrix v contains information relating to the signal arriving angle. The eigenvector matrix v is orthogonal, thus: v⁻¹=v^{T}.

The eigenvectors of h indicate the directions of the strongest paths to the target transceiver. The eigenvalues of h indicate the strength of the strongest paths to the target transceiver. By focusing transmission energy along the strongest paths to the target transceiver (i.e. along the eigenvectors of h), the MIMO network 100 can improve link reliability, capacity, and power efficiency. Decreasing the transmitted signal power also increases security because the signal power leaked to adversaries is automatically reduced statistically. Adjusting the spatial multiplexing matrix to reduce the transmitted power improves the low probability of intercept (LPI) of the MIMO network 100.

The inverse CSI matrix h⁻¹ can be written as: \vec{h}⁻¹=\vec{v}\vec{λ⁻¹}\vec{v}⁻¹. Multiplying both sides by v⁻¹ and reducing gives: \vec{v}⁻¹\vec{t}=\vec{λ}⁻¹\vec{v}⁻¹\vec{x}. \vec{v}⁻¹\vec{t} is the transmitted signal. \vec{v}⁻¹\vec{x} is the un-multiplexed signal projected into a new signal space.

The total transmitted power, Pₜ, is given as: Pₜ=\vec{t}^{T}\vec{t}. Because v is orthogonal, the total transmitted power can be expressed as: Pₜ=(\vec{v}⁻¹\vec{t})^{T}(\vec{v}⁻¹\vec{t}). Substituting in \vec{v}⁻¹\vec{t} gives: Pₜ=(\vec{λ}⁻¹\vec{v}⁻¹\vec{x})^{T}(\vec{λ}⁻¹\vec{v}⁻¹\vec{x}). This can be re-written as: Pₜ=(\vec{v}⁻¹\vec{x})^{T}\vec{λ}⁻²(\vec{v}⁻¹\vec{x}). Further reducing gives:

$${P}_{t} = ( {\sum }_{t = 1}^{M} \frac{1}{{λ}_{t}^{2}} ) {p}_{x}$$

where pₓ is the constant un-multiplexed signal power.

It is desired to reduce the transmitted power while maintaining a constant un-multiplexed signal power at the receiver 150. Reducing the power allows the MIMO network 100 to be power efficient. The theoretical minimal transmitted power can be expressed as:

$$min ( {P}_{t} ) = min ( {\sum }_{t = 1}^{M} \frac{1}{{λ}_{t}^{2}} ) {p}_{x} .$$

The eigenvalues λᵢ indicate the strength of the path in the direction of the strongest paths to the target transceiver. Increasing the strength of the path (i.e. increasing λᵢ) decreases the transmitted power. In one embodiment, the eigenvalues λᵢ can be theoretically maximized by adjusting the transmitting transceiver's antennas 140 and the target transceiver's antennas 160. Processor 320 can control servomechanisms 340 to adjust antennas 310 to maximize the eigenvalues λᵢ. In one embodiment, processor 320 adjusts the antennas, such as the antennas 140 and 160 in the MIMO wireless network 100, to beamform towards each other. Beamforming the antennas 140 and 160 maximizes the eigenvalues of the CSI, leading to high power efficiency.

In one embodiment, the SMM is the inverse of the channel state information. When W is the inverse of h, the signal the second transceiver 150 receives is: y=hh⁻¹x=x. When W is the inverse of h, MIMO system 100 may engage in MIMO eigen-beamforming. During MIMO eigen-beamforming, improved transmitted power efficiency can be achieved. The MIMO system 100 can calculate the information of CSI matrix h and SMM W without taking extra communication bandwidth. The second transceiver 150 receives clear signal x with improved signal strength.

In one embodiment, Nodes 310 and 320 are moving relative to each other. The processor 220 updates the CSI between each data packet exchange, and commands servomechanisms 240 to adjust the antennas 230 to maintain the beamforming. In another embodiment, Nodes 310 and 320 are stationary and beamform towards each other.

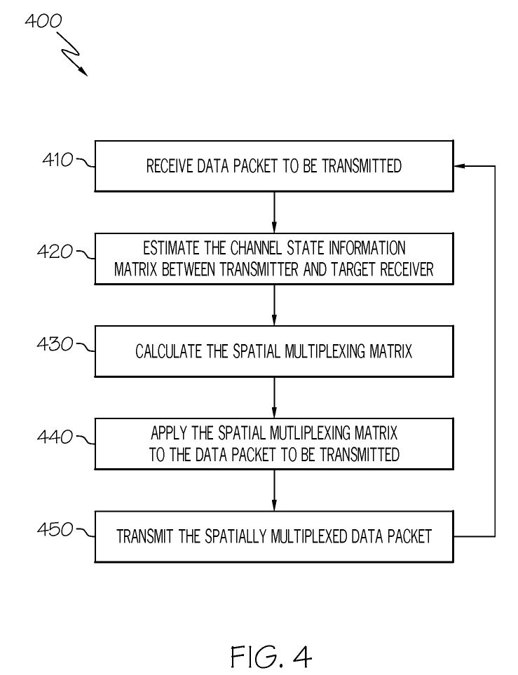

FIG. 4 is a flow chart of one embodiment of a method for enhancing the channel security and power efficiency of a multiple-input-multiple-output wireless network, such as network 100 of FIG. 1. It is understood that the method of FIG. 4 is used, in other embodiments, with other networks. The method of FIG. 4 is described with respect to the network of FIG. 1 by way of example and not by way of limitation. In one embodiment, at block 410, the first transceiver 120 receives a data packet, x, to be transmitted. At block 420, the MIMO wireless network 100 estimates the CSI between the first transceiver 120 and the target second transceiver 150. At block 430, the processor 130 calculates the spatial multiplexing matrix W. At block 440, the processor 130 applies the SMM W to x, the data packet to be transmitted. At block 450, the first transceiver 120 transmits the spatially multiplexed data packet, Wx.

In one embodiment, the method is repeated for successive data packets. In another embodiment, such as during efficiency mode when h is not changing, the processor 130 will not determine a unique SMM for each data packet to be transmitted. In other embodiments, block 420 is not preformed for each subsequent data packet to be transmitted.

In one embodiment, at block 430, the spatial multiplexing matrix W is calculated based on the CSI matrix h between the first transceiver 120 and the target second transceiver 150. In one embodiment, W is calculated to be h₁⁻¹. In another embodiment, W is random. In another embodiment, W is calculated such that hW is a diagonal matrix. In yet another embodiment, h is a quantized scalar.

In one embodiment, before estimating the CSI at block 420, processor 130 reconfigures the antenna patterns of antennas 140. In another embodiment, processor 130 adjusts the position of antennas 140. In another embodiment, the first transceiver 120 is moving, resulting in changes in the channel state information matrix.

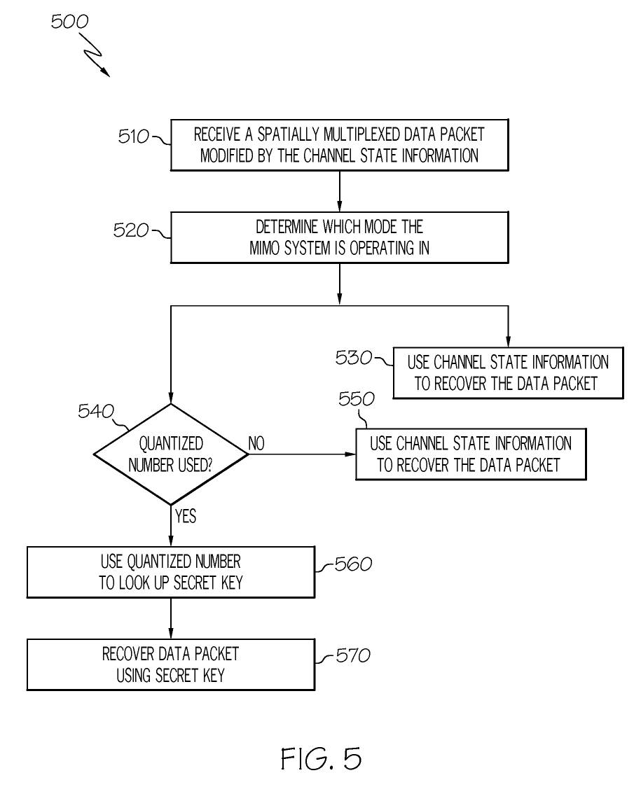

FIG. 5 is a flow chart of one embodiment of a method 500 for a transceiver receiving a data packet in channel security or power efficiency mode of a multiple-input-multiple-output wireless network, such as network 100 of FIG. 1. It is understood that the method of FIG. 5 is used, in other embodiments, with other networks. The method of FIG. 5 is described with respect to the network of FIG. 1 by way of example and not by way of limitation. In one embodiment, at block 510, the transceiver receives a spatially multiplexed data packet which has been modified by the channel state information. The channel state information (CSI) that has modified the spatially multiplexed date packet is the CSI between the transmitting transceiver and the receiving transceiver. At block 520, the receiving transceiver determines whether the MIMO network is using channel security mode. It is noted that the MIMO network, in one embodiment, uses both channel security mode and power efficiency mode at the same time. In other embodiments, only one of channel security mode and power efficiency mode are used at one time. In one embodiment, the receiving transceiver knows what mode the MIMO network is operating in before receiving the data packet.

If the MIMO network is not operating in channel secrecy mode, the method 500 proceeds to block 530. In one embodiment, the spatial multiplexing matrix, W, is the inverse of the channel state information, h. The transceiver estimates the CSI matrix h and estimates the spatial multiplexing matrix, W, and uses these matrices to recover the data packet.

If the MIMO network is operating in channel secrecy mode (either with or without power efficiency mode), the method 500 proceeds to block 540. At block 540, the transceiver determines whether a quantized scalar of the channel state information, h, is used.

If h is not quantized, the method 500 proceeds to block 550. At block 550, the transceiver uses the channel state information matrix to recover the data packet. In one embodiment, W is random subject to the constraint that hW is a diagonal matrix. The transceiver can use various linear algebra methods known to those skilled in the art to recover the data packet from the received signal.

If h is quantized, the method proceeds to block 560. In one embodiment, the scalar which the CSI matrix is quantized to is kept secret between the transceivers in the MIMO wireless network. In one embodiment, h is quantized to an integer. In another embodiment, the integer is used as an index to a shared secret codebook, program, or the like. At block 560, the receiving transceiver can use the quantized number to look up a secret key in an index. At block 570, the receiving transceiver can use the secret key to decode the data packet. The secret key can be generated and utilized with no public discussion which would compromise the security of the communications.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A multiple-input-multiple-output wireless network, comprising:
a first transceiver with M antennas;
wherein the first transceiver is configured to multiplex a data packet by a spatial multiplexing matrix and to transmit the spatially multiplexed data packet to a second transceiver;
wherein the first transceiver is reconfigurable to change the spatial multiplexing matrix to improve at least one characteristic of the transmission; and
wherein the second transceiver has N antennas.

2. The network of claim 1, wherein each of the first transceiver and the second transceiver comprises a processor configured to calculate and apply the spatial multiplexing matrix.

3. The network of claim 2, wherein the processors are configured to adjust the antennas of the first transceiver and the second transceiver to beamform towards each other.

4. The network of claim 2, wherein the processors are configured to change the spatial multiplexing matrix before the first tranceiver transmits a second multiplexed data packet.

5. The network of claim 2, wherein the processors are configured to calculate the spatial multiplexing matrix to be one of the inverse of the channel state information matrix, random, or calculated such that the spatial multiplexing matrix modified by the channel state information matrix is quantized to a scalar.

6. The network of claim 5, wherein
the scalar is known to the second transceiver;
the scalar corresponds with a secret key shared by the first transceiver and the second transceiver; and
the secret key can be passed to upper layers for encryption or authentication of data packets.

7. The network of claim 1, wherein the second transceiver is reconfigured by reconfiguring the second transceiver's antenna radiation characteristics in the physical layer.

8. The network of claim 1, wherein the first transceiver is reconfigured by reconfiguring the first transceiver's antenna radiation characteristics in the physical layer.

9. A method for communicating data, the method comprising:
receiving a data packet to be transmitted;
determining a spatial multiplexing matrix;
applying the spatial multiplexing matrix to the data packet; and
transmitting the spatially multiplexed data packet.

10. The method of claim 9, wherein receiving, determining, applying and transmitting are repeated for subsequent data packets.

11. The network of claim 9, wherein prior to determining a spatial multiplexing matrix, reconfiguring the antenna radiation characteristics in the physical layer of a transmitting transceiver.

12. The method of claim 9, wherein determining the spatial multiplexing matrix determines the spatial multiplexing matrix to be one of the inverse of the channel state information matrix, random, or calculated such that the spatial multiplexing matrix modified by the channel state information matrix is quantized to a scalar.

13. The network of claim 12, wherein if the spatial multiplexing matrix is quantized to an integer number:
the scalar is known to the receiver;
the scalar corresponds with a secret key shared by the transmitter and receiver; and
the secret key can be passed to upper layers for encryption or authentication of data packets.

14. A computer readable storage medium containing a program which, when executed by a processor, performs a process, the process comprising:
calculating a spatial multiplexing matrix;
applying the spatial multiplexing matrix to a data packet; and
sending the spatial multiplexed data packet to a transceiver.

15. The computer readable storage medium of claim 14, wherein the spatial multiplexing matrix is calculated after reconfiguring the antenna radiation characteristics in the physical layer of the transceiver.

16. The computer readable storage medium of claim 14, wherein the spatial multiplexing matrix is calculated to be one of the inverse of the channel state information matrix, random, or calculated such that the spatial multiplexing matrix modified by the channel state information matrix is quantized to a scalar.
